(19) United States
(12) Patent Application Publication
(10) Pub. No.: US 2004/0107917 A1
(43) Pub. Date: Jun. 10, 2004

(54) Pet toy

(76) Inventor: Norbert Joseph Gerlach, Paramus, NJ (US)

Correspondence Address: Norbert Gerlach, 150 Stuart St., Paramus, NJ, 07652, US

(21) Appl. No.: 10/309,368

(22) Filed: Dec. 5, 2002

(51) Int. Cl. A01K 29/00

(52) U.S. Cl. 119/708

(57) ABSTRACT

An improved pet toy intended to fulfill the cardiovascular needs of pets while limiting the training necessary of the animal and the exertion necessary of the user to meet such needs. The pet toy comprises at least one section of rope, at least one object fixably engaged with the rope, and at least one slide member slidably engaged with the rope, where the slide member has a lumen of sufficient diameter to allow the rope to pass freely therethrough.

### BACKGROUND OF THE INVENTION

1) Field of the Invention

The present invention relates to a pet toy which provides the pet with a healthy level of cadrio-vascular exercise while demanding of the owner a lower level of exertion.

2) Description of the Prior Art

The exercise and entertainment of pets is a constant effort for pet owners. Activity and attention are necessary for the continued development and growth of contented pets and their socialization with humans. The growth in the industry of such pet toys is indicative of the importance pet owners place upon their pets. It also indicates that not all toys entertain all pets nor are all pets able to get enough exercise with such toys.

Up until now, most pet toys are either those that can be used in close proximity with the pet, such as tug toys or they are used outdoors for chase or fetch games, such as flying discs and other thrown objects. Both of these types of toys have certain drawbacks.

For close proximity toys, while they do entertain and provide some exercise portion, they fail to provide a heightened level of cardio-vascular exertion such as running. In most cases, the owners themselves are not able to reach that level either nor are they able to sustain it over a sufficiently long period of time for the exercise to have a beneficial affect.

For fetch toys, a certain level of training is required for the pet to return the object that they were sent to retrieve. And they must return it to the owner in order for the process to be repeated. And if not returned by the pet, the owner must go to the area where the toy was thrown for the process to be repeated.

There exists another type of pet toy that trys to overcome the drawbacks stated above. Such toys are similar in nature to fishing rods where an object is “cast” via an attachment that may then be recovered by a “retrieval” mechanism. The intent of these toys is to provide tugging methodology of play, again placing these within the realm of tug toys.

### SUMMARY OF THE INVENTION

The present invention has been developed to fulfill the cardio-vascular needs of pets while limiting the training necessary of the animal and the exertion necessary of the user to meet such needs. The pet toy has at least one section of rope, at least one object fixably engaged with the rope, and at least one slide member slidably engaged with the rope, where the slide member has a lumen of sufficient diameter to allow the rope to pass freely therethrough.

The pet toy may have a drag element to reduce the speed at which the rope may be drawn through the slide member. The drag element may further have a means for gathering the rope to limit the amount of rope in play.

The pet toy may further have a safety clip so the rope may be disengaged from the drag element and the slide member.

The pet toy may further have projections attached to the slide member so that the rope may be wound around the projection when the pet toy is not in use.

The pet toy may further have an object attached that is flavored, scented, or equipped with a noisemaker.

Still further, the pet toy may have an object that may be detached from the rope for use as a chew toy.

The aforementioned objects, features, and advantages of the invention will, in part, be pointed out with particularity, and will, in part become obvious from the following more-detailed description of the invention. Taken in conjunction with the accompanying drawings, which form an integral part thereof.

### BRIEF DESCRIPTION OF THE DRAWINGS

FIG. 1 is an overview of a pet toy constructed in accordance with the present invention and showing a rope, an object, a slide member, a drag element, and a safety clip.

### DETAILED DESCRIPTION OF THE PERFERRED EMBODIMENTS

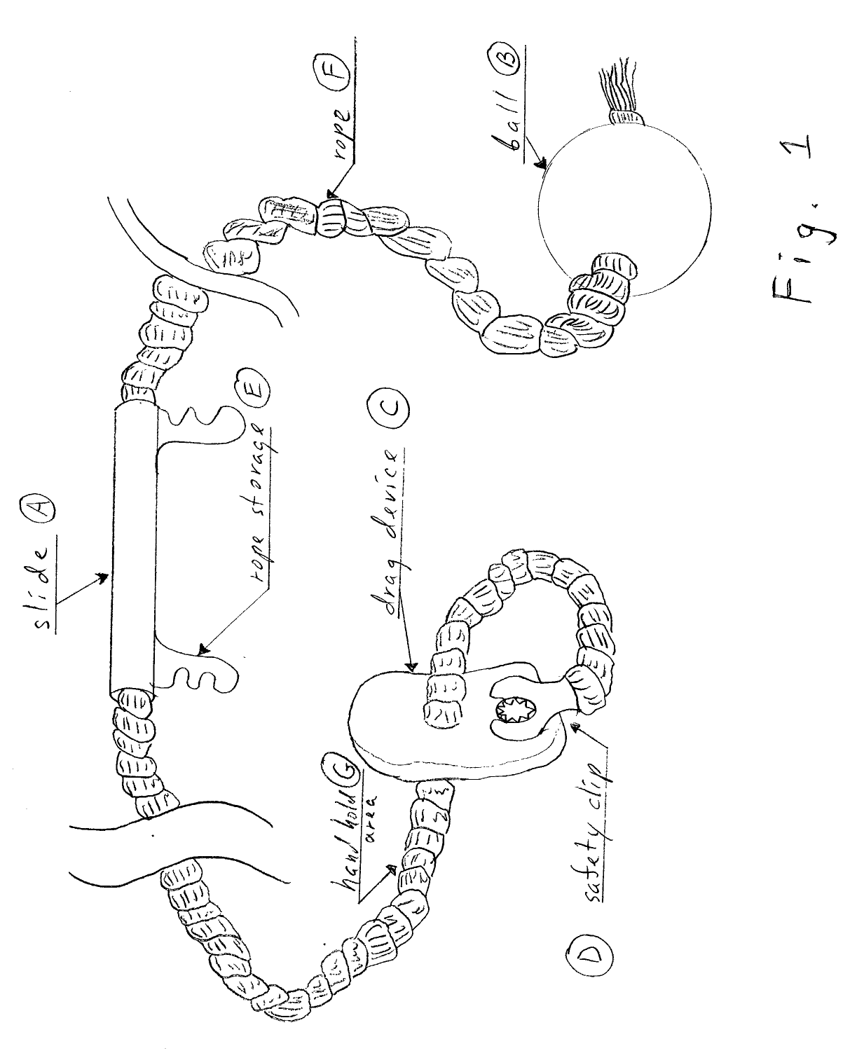

The present invention will now be described in conjunction with FIG. 1.

The present invention comprises a rope (F). The rope being of sufficient length to permit object (B) attached to one end to lay on the ground when a user is holding the toy by slide (A) with his or her arm outstretched parallel to the ground.

The present invention further comprises a slide (A) that acts as a handle for manipulating the rope and attached object. The slide having a lumen (H) of sufficient size to allow the rope to pass with a minimum of resistance. The length of the slide (A) is preferably between ten and 24 inches, however the length need only be long enough to provide a fulcrum for movement of the object (B), and can be as long as desired. The slide (A) allows the user to swiftly slide his hand along the rope (F) while holding his other hand stationary on the rope at the handhold position (G) or moving his hand in the direction away from the slide (A). This action accelerates the object (B) faster and in a greater arc than what a simple swinging of the rope would produce. The slide (A) provides the user with greater control over the object (13), its position, and its speed.

The object (B) is attached to the distal end of the rope (F) and can be made of materials such as spongerubber, hard rubber, or any other material deemed sufficiently durable to withstand the chewing action of the pet's jaws without causing harm. The object can be shaped as a ball, an animal, or any shape that would be desirable as a toy for a pet. Further, the object (B) may be scented, flavored, or have a noise maker associated therewith.

The rope (F) can be made of any suitable material including natural fibers and synthetic fibers such as polypropylene. Further the rope's weave and thickness is highly variable but must be of sufficient durability to withstand the rigors of animal chewing, pulling and tearing, while passing through the lumen (H) of slide (A) with a minimum of resistance.

The slide (A) may include a molded-in series of indents (not shown) for gripping the slide (A), and projections (E) to provide a rope storage place for storing the rope when not in use.

The present invention further comprises a drag device (C). The drag device provides protection for both the pet and the user if the pet grabs the toy and continues to travel away from the user, the drag device will slow the tug of the rope without causing an abrupt halt to the travel of the rope. This protects the pet from any hard yanks to its head. Additionally, the drag device (C) provides a means for slowing the drawing of the rope (F) through the slide (A) when an orifice in the drag device (C) is substantially the same as the thickness of the rope (F). The friction caused by the interaction of the rope (F) and the drag device (C) slows the travel of the rope (F) through the slide (A).

The drag device (C) also provides a handhold position (G) on rope (F) for one of the user's hands when operating the pet toy. When the user's arms are swung in opposite directions, the drag device (C) enables the user to pull on the drag device (C) while gripping the rope (F). In the event that a pet should grab the object (B) and run away from the user the proximity of the handhold position (G) and the drag device (C) allows the user to switch gripping positions from the rope (F) to the drag device (C), thus preventing possible rope burn

Further, the present invention comprises a safety clip (D) that in conjunction with the drag device (C) assists the user in gathering the proximal end of the rope, keeping any excess from dragging on the floor or causing the user from getting tangled up in it. In addition, the safety clip (D) can easily disconnect from the drag device allowing the entire rope (F) to pass through the slide (A), thus eliminating any choking hazard for the pet or user caused by the loop of rope. Still further the safety clip (D) prevents injury to the pet which could be caused by an abrupt halt to the travel of the rope.

In addition to the equivalents of the claimed elements, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. Those skilled in the art will appreciate the various adaptations and modifications of the just-described preferred embodiment can be configured without departing from the scope and spirit of the invention. The illustrated embodiment has been set forth only for the purposes of example and that should not be taken as limiting the invention. Therefore, it should be understood that, within the scope of the appended claims, the invention may be practiced other than as specifically described herein.

What is claimed is:

1. A pet toy comprising:
at least one section of rope;
at least one object fixably engaged with said rope;
at least one slide member slidably engaged with said rope, said member having a lumen of sufficient diameter to allow said rope to pass freely therethrough.

2. The pet toy of claim 1, further comprising;
a drag element having the rope passing there through, wherein said drag element reduces the speed at which said rope may be drawn through said slide member.

3. The pet toy of claim 2, wherein said drag element further comprises a means for gathering said rope to limit the amount of said rope in play

4. The pet toy of claim 1, further comprising;
a safety clip, wherein said rope may be disengaged from said drag element and said slide member.

5. The pet toy of claim 1, further comprising;
projections attached to said slide member, wherein said rope may be wound around said when the pet toy is not in use.

6. The pet toy of claim 1, wherein said object is flavored.

7. The pet toy of claim 1, wherein said object is scented.

8. The pet toy of claim 1, wherein said object further comprises a noisemaker.

9. The pet toy of claim 1, wherein said object may be detached from said rope for use as a chew toy.

10. A method of exercising a pet using the apparatus recited in claim 2 comprising:
projecting the slide along the rope in the direction of the object;
pulling the rope in a direction away from the object, wherein the combined motions moves the object away from the pet causing the pet to chase the object.

11. The method recited in claim 10, further comprising:
a casting step wherein while gripping the slide, using a throwing motion to project the object away from a user.

12. The method recited in claim 11, further comprising:
an initial gathering in step wherein a portion of the rope is pulled through the slide in preparation for the casting step, the gathering step shortening the amount of rope projecting from the distal end of the slide to ease the casting step.

13. The method recited in claim 10, wherein a user spins in a circle keeping the object out of reach of the pet when the pet chases the object.
